(19) United States
(12) Patent Application Publication
(10) Pub. No.: US 2003/0100297 A1
(43) Pub. Date: May 29, 2003

(54) Method of software configuration assurance in programmable terminal devices

(76) Inventors: Kenneth B. Riordan, Spring Grove, IL (US); Steve Raymond Bunch, Harvard, IL (US); Kevin Michael Cutts, Schaumburg, IL (US)

Correspondence Address: MOTOROLA INC, 600 NORTH US HIGHWAY 45, LIBERTYVILLE, IL, 60048-5343, US

(21) Appl. No.: 09/996,628

(22) Filed: Nov. 27, 2001

(51) Int. Cl. H04M 3/00

(52) U.S. Cl. 455/418; 455/414

(57) ABSTRACT

In a communication system, a privilege to access and to operate within a communication network (102) is granted to a terminal device (104) by use of a certificate from the communication network. In addition to granting privileges, the certificate may require the terminal device to update its software and configuration by requiring the terminal device to perform any combination of the following: downloading a different version of software and/or configuration, setting an allowable range of operation, and suspending operations outside of the allowed range. The communication network keeps a current list of type-approved software versions and configurations which the terminal device may utilize, and compares the software and configuration of the terminal device against the list to determine appropriate measures.

### FIELD OF THE INVENTION

The present invention relates generally to the field of radio communications. More specifically, the present invention relates to a method of assuring software configuration in programmable terminal devices.

### BACKGROUND OF THE INVENTION

For a wireless terminal device, such as a wireless radiotelephone, an ability to download software including Over-the-Air (OTA) is an emerging requirement. With software defined radio (SDR) technology, a terminal device such as a subscriber radiotelephone will be able to download software including core software. Core software, or native software, is software which runs in an unprotected environment, and could have unlimited access to data and resources loaded on the terminal. This ability of core software to access such information will present problems and concerns to network operators who provide communication to the radiotelephone. The operators' problems and concerns, relating to configuration control of terminals in their networks, will include how to recognize the safety and qualification of the software versions and configurations, and to allow or to disallow such software operation. A supplier for these terminals will also face problems and concerns including how to identify its software to the network and how to have the terminal software securely respond to the network's direction to allow or disallow the software operation.

Another area of concern is when a terminal is roaming outside of its home network. The terminal may contain a software version and configuration incompatible with the roaming host network. Similarly, if the terminal had downloaded a software configuration from the roaming host network then returned to its home network, the terminal might no longer be compatible with its home network.

Software version and configuration, which were originally considered acceptable, may later be determined unacceptable. In such case, a network operator may wish to disallow the software from operating by some means.

Accordingly there is a need for the network operators to be able to control the allowed range of operations of the terminals within the network.

### BRIEF DESCRIPTION OF THE DRAWINGS

FIG. 1 is a block diagram of a communication system comprising a communication network and a terminal device;

FIG. 2 is a flowchart of a preferred embodiment of the present invention for the communication network;

FIG. 3 is a flowchart of a preferred embodiment of the present invention for the terminal device;

FIG. 4 is a flowchart of another aspect of the preferred embodiment of the present invention for the communication network; and

FIG. 5 is a flowchart of another preferred embodiment of the present invention for the terminal device.

### SUMMARY OF THE INVENTION

The present invention describes a method for a communication network to selectively grant a terminal device a privilege allowing a use of a specific version and configuration of software to access the communication network when the terminal device makes a request to operate within a targeted network. The privilege is granted by the use of an execution certificate which is a numerical value derived by using a cryptographic technique. The execution certificate contains information regarding allowable versions of software and allowable configuration of software, and configures the terminal device consistent with the target network in which the terminal device is to operate. If a version of software unapproved for use in the targeted network is detected, an approved version may be downloaded to the terminal device, or the network may send another execution certificate revoking the previously granted privilege.

### DETAILED DESCRIPTION OF A PREFERRED EMBODIMENT

The present invention provides a method for a communication network to grant privileges to a terminal device, such as a radiotelephone having a specific version of software and software and hardware configuration, to access and operate in the communication network. The communication network allows the terminal device to download a version of software from the network if the terminal device contains disapproved software.

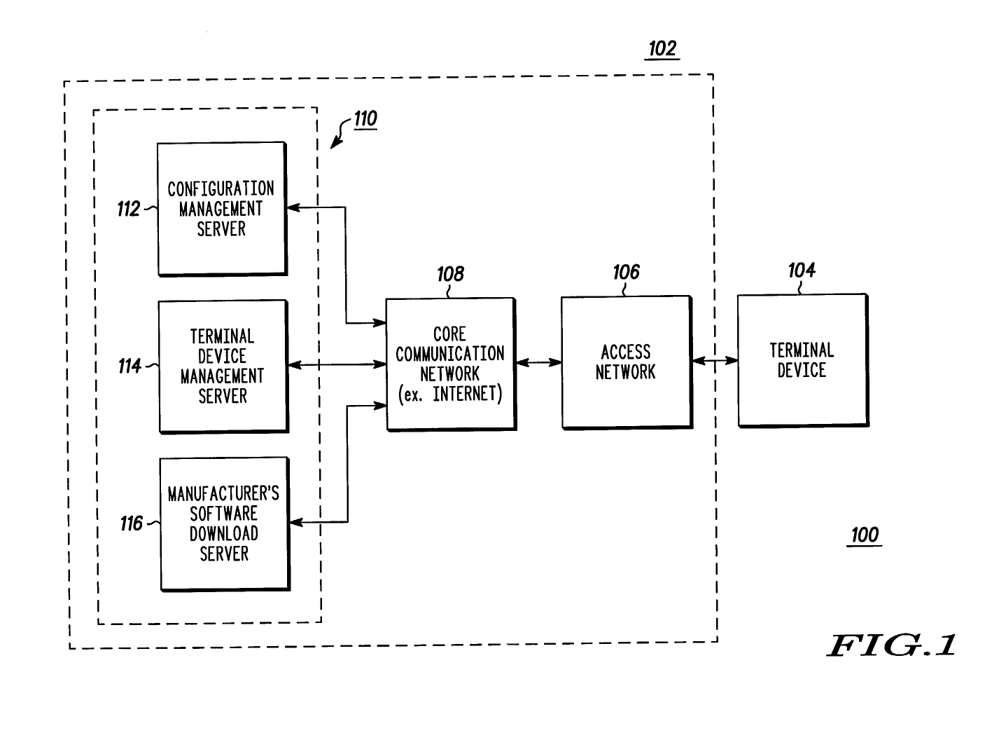

FIG. 1 illustrates a block diagram of a communication system (100) employing a preferred embodiment of the present invention comprising a communication network (102) and a terminal device (104). The communication network (102) comprises an Access Network (106), a Core Communication Network (108), a host computer or server (110), which comprises a Configuration Management Server (112), a Terminal Device Management Server (114), and a Manufacturer's Software Download Server (116). The communication network (102) stores in its memory a version list which contains information regarding currently type-approved versions of software and configurations that the terminal device may use to access and to operate in the communication system. The communication network updates the version list by receiving an updated version list from the host computer (110) by way of the Core Communication Network (108).

The Configuration Management Server (112) contains a database which describes approved and disapproved hardware and software configurations. The database contains, at a minimum, a unique software identifier (“type”), a software version indicator (“revision”), and a cryptographic checksum (“checksum”) which collectively identify the software, and allow verification that it has been fetched correctly. This information may be presented to the Manufacturer's Software Download Server (116) to fetch a copy of the designated software.

The Terminal Device Management Server (114) enables the communication network to remotely manage the terminal device. The remote management may include a device configuration interrogation and software download. This server uses the type, revision, and checksum, as well as other information that may be available to uniquely identify the terminal device, and computes an execution certificate which is then sent to the terminal device (104).

The Manufacturer's Software Download Server (116) contains new software releases including core software. Contents from the server may be electronically signed by the manufacturer allowing the terminal device to process the contents according to security protocol running in the terminal device. This server may be accessed by the Terminal Device Management Server (114).

Whenever information is sent or received among the blocks (102, 104, 106, 108, 110, 112, 114, and 116) in the communication system (100), the information may be coded using cryptographic techniques to avoid forgery of the information.

At any given time, the terminal device possesses one or more terminal execution certificates, each of which contains information regarding the configuration of software and hardware as well as the version information of software that are currently loaded in the terminal device. In the description below, the phrase, “terminal execution certificates,” implies one or more terminal execution certificates.

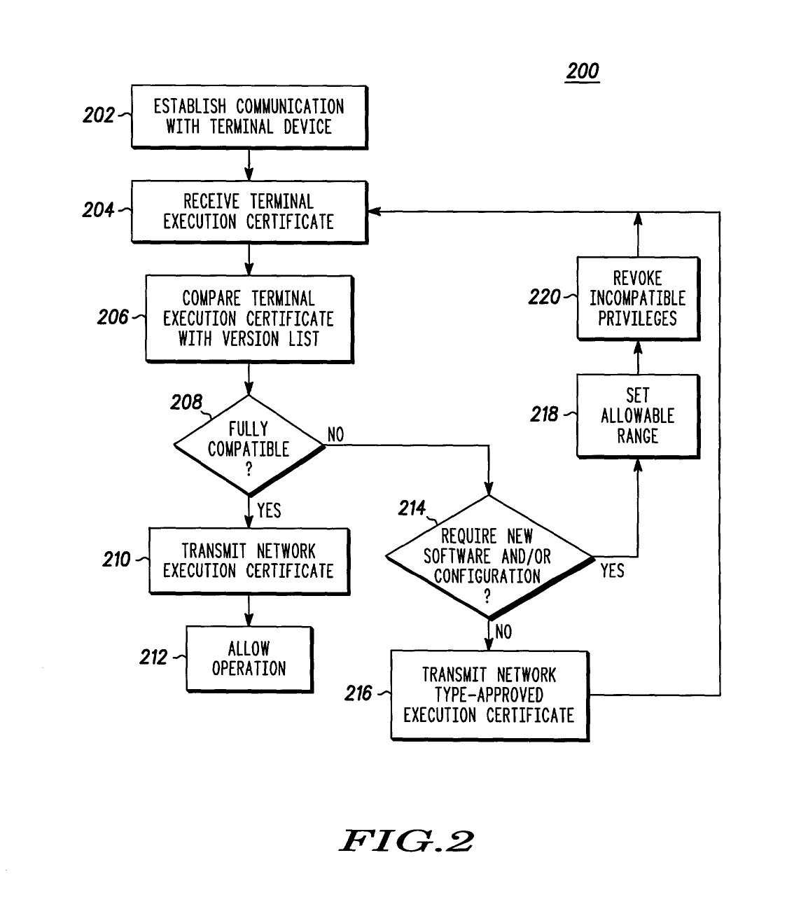

FIG. 2 illustrates a flowchart of a first preferred embodiment of the present invention which is for the communication network. When the communication network (102) establishes communication (202) with the terminal device (104), it receives a terminal execution certificate (204) from the terminal device. The communication network also receives a terminal execution certificate when a terminal device is handed off from another communication network to the present communication network. Upon receiving the terminal execution certificate, the communication network compares it with its version list (206). If it determines that the terminal device is configured properly and fully compatible (208), then it transmits to the terminal device a network execution certificate (210) which grants the terminal device privileges to fully operate with the communication network (212).

If the communication network determines that the terminal device is not compatible and requires downloading new software and/or configuration (214), it transmits to the terminal device a network type-approved execution certificate (216), which contains information regarding type-approved versions of software and configurations for the terminal device consistent with the version list, and instructs the terminal device to update its software and configuration to be compatible with the communication network. This step may include allowing the terminal device to download an approved version of software from the communication network. When the terminal device is a new one and establishes communication for the first time, its terminal execution certificate has a form of a provisional certificate. The provisional certificate contains the hardware and software configuration of the new terminal device and permits the new terminal device to operate only a restricted set of operations with the communication network. If the provisional certificate is not fully compatible, the communication network will also transmit to the terminal device a type-approved execution certificate, and will instruct the terminal device to update its software and configuration to a type-approved version, using only the permitted restricted set of operations.

If the communication network determines that the terminal device is not fully compatible but does not require new software or configuration (214), then it may set the range of allowable operation (218) and transmit a message to the terminal device revoking privileges (220) to operate outside of the allowable operation range without requiring to update software or configuration.

After transmitting the request to update or the allowable range of operation to the terminal device, the communication network receives an updated terminal execution certificate from the terminal device (204), and the process begins over. The communication network will not allow the terminal device to operate in the network till the network execution certificate is transmitted to the terminal device. A limit may be placed on the number of re-submission of the terminal execution certificate by the terminal device (204) to prevent unnecessary system tie-ups.

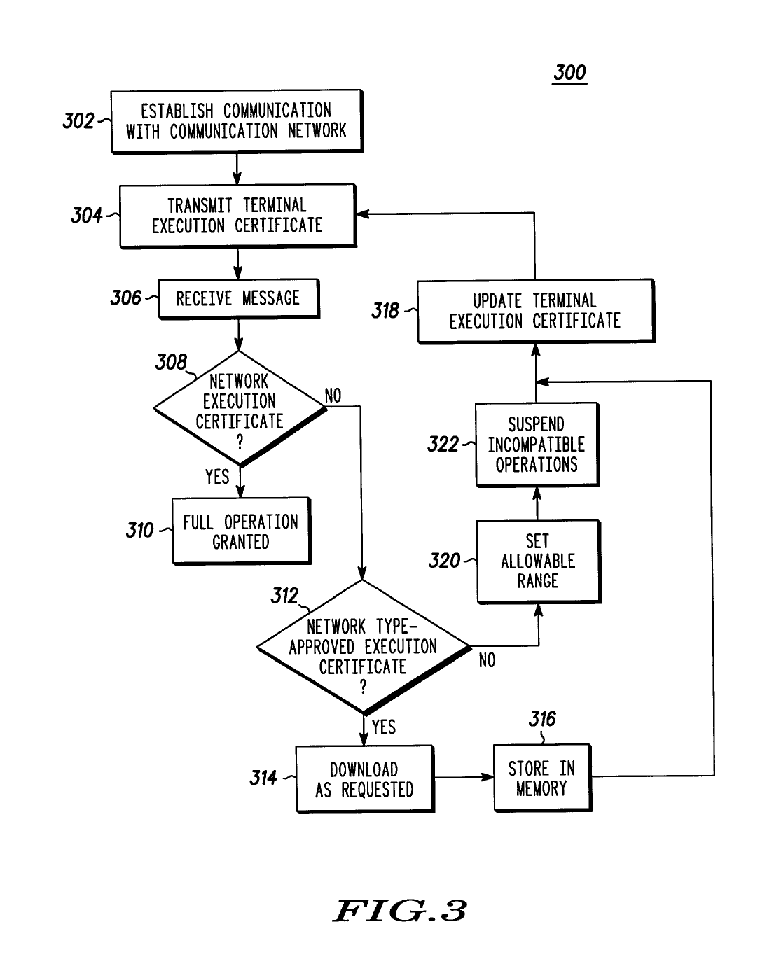

FIG. 3 illustrates a flowchart of a second preferred embodiment of the present invention which is for the terminal device. When the terminal device (104) establishes communication (302) with the communication network (102), it transmits a terminal execution certificate (304) to the communication network. The terminal device also transmits a terminal execution certificate when it is handed off from one communication network to another communication network. The terminal device then receives a response form the communication network (306). If the response is a network execution certificate (308), indicating that the communication network has determined that the terminal device is fully compatible with the communication network based upon the comparison between the terminal execution certificate and the version list, then the terminal device is allowed to fully operate with the communication network (310).

If the response is a network type-approved execution certificate (312), requesting or commanding the terminal device to update to appropriate new software and/or configuration provided by it, the terminal device downloads (314) and stores (316) in a terminal memory appropriate software and/or configuration as requested. The terminal device then updates the terminal execution certificate (318) to reflect the updating, resends this terminal execution certificate back to the communication network, and the process starts over.

If the response sets an allowable range (320) of the terminal device operation by revoking the privileges granted to the terminal device to operate certain software and/or configuration, the terminal device suspends such operations (322) conforming to the allowable range of operation set by the communication network without having to download new software or configuration. The terminal device then updates the terminal execution certificate (318) to reflect the updating, resends this terminal execution certificate back to the communication network, and the process starts over. The process of setting the allowable range and suspending certain operation may be required in addition to downloading new software and/or configuration. A limit may be placed on the number of re-submission of the terminal execution certificate by the terminal device (304) to prevent unnecessary system tie-ups.

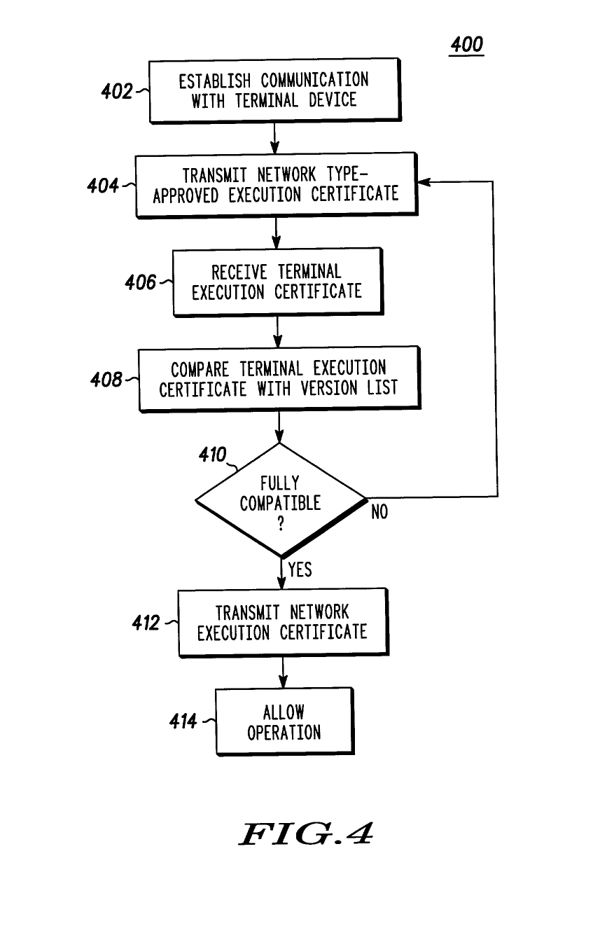

FIG. 4 illustrates a flowchart of a third preferred embodiment of the present invention which is for the communication network. When the communication network (102) establishes communication (402) with the terminal device (104), it transmits to the terminal device a network type-approved execution certificate (404), which contains information regarding type-approved versions of software and configurations for the terminal device consistent with the version list. This step may include allowing the terminal device to download an approved version of software from the communication network. The communication network also transmits the network type-approved execution certificate when a terminal device is handed off from another communication network to the present communication network. The communication network then receives a terminal execution certificate (406) from the terminal device. Upon receiving the terminal execution certificate, the communication network compares it with its version list (408). If it determines that the terminal device is configured properly and fully compatible (410), then it transmits to the terminal device a network execution certificate (412) which grants the terminal device privileges to fully operate with the communication network (414).

If the communication network determines that the terminal device is not fully compatible (410), then it re-transmit to the terminal device the type-approved execution certificate (404), and the process begins over. The communication network will not allow the terminal device to operate in the network till the network execution certificate is transmitted to the terminal device. A limit may be placed on the number of re-submissions of the terminal execution certificate by the terminal device (406) to prevent unnecessary system tie-ups.

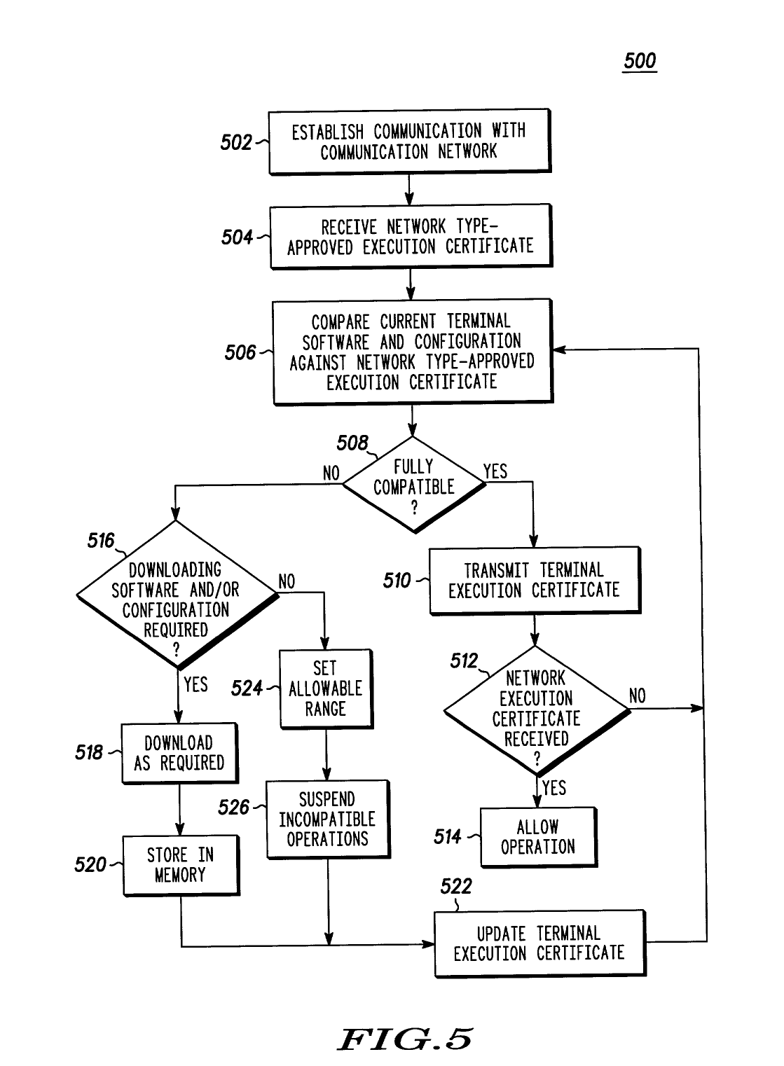

FIG. 5 illustrates a flowchart of a fourth preferred embodiment of the present invention which is for the terminal device. When the terminal device (104) establishes communication (502) with the communication network (102), it receives a network type-approved execution certificate, which contains information regarding type-approved versions of software and configurations for the terminal device for operation with the communication network, from the communication network (504). When the terminal device is handed off from one communication network to another, it also receives a network type-approved execution certificate from the other communication network. The terminal device then compares its current software and configuration against the network type-approved execution certificate (506), and determines its compatibility with the communication network.

If the terminal device determines that it is fully compatible (508) with the communication network, it transmits its current terminal execution certificates reflecting its current software and configuration to the communication network (510). It then waits to receive a network execution certificate from the communication network grating privileges to the terminal device full operation of its current software and configuration (512). When the terminal device receives the network execution certificate, it begins its operation with the communication network (514). If the terminal device does not receive the network execution certificate after a preset time period, or it receives a message indicating that the communication network has refused to issue the network execution certificate, then the terminal device starts over the process from comparing its current software and configuration against the network type-approved execution certificate (506). A limit may be placed on the number of re-submission of the terminal execution certificate by the terminal device (510) to prevent unnecessary system tie-ups.

If the terminal device is not fully compatible (508) with the communication network, it then determines if downloading software and/or configuration from the communication network is required to become compatible with the communication network (516). If downloading is required, the terminal device downloads appropriate software and/or configuration from the communication network as required (518), and stores in its memory (520). The terminal device then updates its terminal execution certificates (522), and starts over the process from comparing its current software and configuration against the network type-approved execution certificate (506). A limit may be placed on the number of re-submission of the terminal execution certificate by the terminal device (510) to prevent unnecessary system tie-ups.

If downloading is not required but modifying its current software and/or configuration setup is required, the terminal device sets an allowable range of operation that is compatible and suspends operations that are incompatible with the communication network. The terminal device then updates its terminal execution certificates (522), and starts over the process from comparing its current software and configuration against the network type-approved execution certificate (506). The process of setting the allowable range and suspending certain operation may be required in addition to downloading new software and/or configuration. A limit may be placed on the number of re-submission of the terminal execution certificate by the terminal device (510) to prevent unnecessary system tie-ups.

The present invention focuses on a method for a communication network to grant privileges to a terminal device such as a radiotelephone. However, it may be used in other areas of communication systems such as, but not limited to, a wired or wireless LAN system with a master server and a client terminal.

While the preferred embodiment of the invention has been illustrated and described, it is to be understood that the invention is not so limited. Numerous modifications, changes, variations, substitutions and equivalents will occur to those skilled in the art without departing from the broad scope of the present invention as defined by the appended claims.

What is claimed is:

1. A method for a communication network for granting privileges to a terminal device having a specific version of software allowing the terminal device to operate in the communication network, the communication network storing in a network memory operably coupled to the communication network a version list comprising a plurality of type-approved versions of software and configurations for the terminal device, the method comprising steps of:
receiving a terminal execution certificate of the terminal device from the terminal device wherein the terminal execution certificate comprises information regarding a version of software and a configuration of the terminal device; and,
allowing an operation of the terminal device consistent with the version list within the communication network.

2. A method according to claim 1 wherein the terminal execution certificate is a provisional certificate allowing the terminal device a restricted set of operations with the communication network.

3. A method according to claim 1 further comprising steps of receiving an updated version list from a host computer coupled to the communication system wherein the host computer has knowledge of a plurality of versions of currently approved software for specific terminal device, and storing the updated version list in the network memory.

4. A method according to claim 1 further comprising a step of receiving the terminal execution certificate from the terminal device being handed off from another communication system.

5. A method according to claim 1 further comprising a step of revoking previously granted privileges to the terminal device for operating certain software and configuration that are inconsistent with the version list.

6. A method according to claim 1 further comprising a step of transmitting a network type-approved execution certificate to the terminal device wherein the network type-approved execution certificate comprises information regarding type-approved versions of software and configurations for the terminal device consistent with the version list.

7. A method according to claim 1 further comprising a step of transmitting a network execution certificate to the terminal device wherein the network execution certificate grants privileges to the terminal device for operating certain software and configuration consistent with the version list within the communication network.

8. A method according to claim 1 further comprising a step of setting a range of allowable operations of the terminal device with communication network by comparing the terminal execution certificate and the version list.

9. A method according to claim 8 further comprising a step of determining availability of an approved version of software downloadable by the terminal device.

10. A method according to claim 9 further comprising a step of transmitting the network execution certificate having a notification of availability of an approved version of software downloadable by the terminal device.

11. A method according to claim 10 further comprising a step of allowing the terminal device to download the approved version of software.

12. A method for a terminal device having a specific version of software stored in a terminal memory for receiving privileges to operate in a communication network, the network storing in a memory operably coupled to the communication network a version list comprising a plurality of type-approved versions of software and configurations for the terminal device, the method comprising steps of:
transmitting a terminal execution certificate of the terminal device to the communication network wherein the terminal execution certificate comprises information regarding a version of software and a configuration of the terminal device; and,
operating within the communication system consistent with the version list.

13. A method according to claim 12 wherein the terminal execution certificate is a provisional certificate allowing the terminal device a restricted set of operations with the communication network.

14. A method according to claim 12 further comprising a step of suspending operations that are inconsistent with the version list by relinquishing previously granted privileges to the terminal device.

15. A method according to claim 12 further comprising a step of transmitting the terminal execution certificate to another communication network for a hand off.

16. A method according to claim 12 further comprising a step of receiving a network execution certificate from the communication network wherein the network execution certificate grants privileges to the terminal device for operating certain software and configuration consistent with the version list within the communication network.

17. A method according to claim 16 further comprising a step of receiving the network execution certificate having information regarding availability of an approved version of software downloadable by the terminal device.

18. A method according to claim 17 further comprising a step of downloading the approved version of software.

19. A method according to claim 12 further comprising a step of receiving a network type-approved execution certificate from the communication network wherein the network type-approved execution certificate comprises information regarding type-approved versions of software and configurations for the terminal device consistent with the version list.

20. A method according to claim 19 further comprising a step of setting a range of allowable operations of the terminal device within the communication network by comparing the terminal execution certificate and the network type-approved execution certificate.

21. A method according to claim 20 further comprising a step of determining availability of an approved version of software downloadable by the terminal device.

22. A method according to claim 21 further comprising a step of downloading the approved version of software.

23. A method according to claim 22 further comprising a step of storing the downloaded approved version of software in the terminal memory.
